(19) United States
(12) Patent Application Publication
(10) Pub. No.: US 2005/0272606 A1
(43) Pub. Date: Dec. 8, 2005

(54) Plant life control composition

(76) Inventor: Frank Manchak JR., La Quinta, CA (US)

Correspondence Address: DARBY & DARBY P.C., P. O. BOX 5257, NEW YORK, NY, 10150-5257, US

(21) Appl. No.: 11/093,273

(22) Filed: Mar. 28, 2005

Related U.S. Application Data
(63) Continuation of application No. 10/130,612, filed on May 17, 2002.
(60) Provisional application No. 60/166,559, filed on Nov. 19, 1999.

(51) Int. Cl. A01N 25/00; A01N 63/00

(52) U.S. Cl. 504/116.1

(57) ABSTRACT

Plant life control composition including stabilized chlorine dioxide. A method of controlling plant life or removing contaminants from plant life comprising contacting the plant life with a composition including stabilized chlorine dioxide. The plant life control composition also may include one or more of he following: a flow agent, a drift control agent, a surface retention agent, a fire retardant agent and mixtures thereof. The composition may be applied to the plant life by spraying or introduction into the earth near the root system of the plant life.

### CROSS REFERENCE TO RELATED APPLICATION

This application is a continuation of U.S. patent application Ser. No. 10/130,312, filed May 17, 2002, now pending, which is the U.S. National Phase of International Application Serial No. PCT/US00/31662, filed Nov. 17, 2000 and published in English on May 25, 2001 under WIPO Publication No. WO 01/35746, which claims the benefit under 35 U.S.C. §119 of U.S. Provisional Application No. 60/166,559, filed Nov. 19, 1999. The prior applications are hereby incorporated by reference in their entirety.

### FIELD OF THE INVENTION

The present invention relates to plant life control compositions and, more particularly, to compositions containing an effective amount of chlorine dioxide for use in the control of plant life. The invention also relates to a method for controlling plant life and a method for cleaning plant life contaminated by pesticides, waxy residues, or other pollutants using compositions containing an effective quantity of chlorine dioxide.

### BACKGROUND OF THE INVENTION

The control of plant life has varied and important applications. Plant life control is practiced on a wide variety of plant types in areas ranging from urban to rural, for both useful and aesthetic reasons.

The primary method of controlling plant life throughout the world continues to be the use of toxic herbicides. These herbicides pose hazards to health, safety and the environment. In the first quarter of the 20th century, organics such as sodium chlorate, sodium chloride, ammonium sulfamate, arsenic and boron compounds, were used as herbicides. Thereafter, more specific organic compounds, such as 2, 4-dichlorophen oxyacetic acid (2, 4, -D) were introduced. Conventionally, herbicides may be of two types, selective, such as 2, 4, D; 2, 4, 5-T (2,4,5-trichlorophenoxyacetic acid); phenols, carbonates, and urea derivatives, which may eliminate weeds without damaging crops, or non-selective, comprising soil sterilants such as sodium compounds and ammonium sulfate.

Toxic herbicides may pose a threat to people and the environment in several ways. For example, they may be carried to unintended locations during application, or enter water supplies when herbicide containers are cleaned or disposed of. Persistence of herbicidal residues on treated crops may carry herbicides to consumers. Herbicides which sterilize the soil or are slow to degrade may permanently poison the environment, making replanting of treated areas impossible. Even in areas such as industrial sites, railways and roads, where it may be preferred that the herbicide's activity persist, the effect on surrounding regions must be considered.

The need to protect the public and the environment from such hazards has prompted legislation to regulate herbicides. For example, the Environmental Protection Agency (EPA) has sought to regulate the use of existing herbicides and to establish procedures for the approval of new herbicides. Legislation has also been directed to the use and application of such herbicides, such as requiring no-spray buffer zones around controlled plant life. These regulations have prevented the use of many conventional herbicides and added to the costs of regulatory compliance for those allowed. As a consequence, herbicide manufacturers and users have been left scrambling for alternatives to conventional toxic herbicides. Public recognition of the dangers and environmental impact of toxic herbicides has also heightened, further increasing the pressure to find alternative non-toxic plant control compositions.

Until suitable alternatives to conventional toxic herbicides can be found, there will continue to be a problem with the contamination of plant life destined for human consumption. Residues from herbicides and pesticides, as well as other pollutants may accumulate on plant life and find their way to the consumer. The problem is particularly acute in the case of plants, such as apples and cucumbers, having a waxy residue which may trap pesticides, herbicides and other pollutants, making removal more difficult. Accordingly, there is also a need to find effective cleaning methods for plant life that will reduce or eliminate pesticides, herbicides, waxy residues and other pollutants accumulated on the surface of the plant life.

### SUMMARY OF THE INVENTION

Accordingly, the present invention provides a composition for controlling plant life, including an effective amount of stabilized chlorine dioxide, and optionally containing an additive selected from the group consisting of a flow agent, a drift control agent, a surface retention agent, a fire retardant agent and mixtures thereof.

The present invention also provides a method of controlling plant life, including the step of contacting the plant life with a composition including an effective amount of stabilized chlorine dioxide.

The present invention further provides a method for cleaning contaminated plant life including the steps of contacting externally contaminated plant life with a composition including an effective amount of stabilized chlorine dioxide and removing the composition from the plant life.

### DETAILED DESCRIPTION OF THE INVENTION

The terms used in this specification generally have their ordinary meanings in the art, within the context of this invention and in the specific context where each term is used. Certain terms are discussed below, or elsewhere in the specification, to provide additional guidance to the practitioner in describing the devices and methods of the invention and how to make and use them. For convenience, certain terms are highlighted, for example using italics and/or quotation marks. The use of highlighting has no influence on the scope and meaning of a term; the scope and meaning of a term is the same, in the same context, whether or not it is highlighted. It will be appreciated that the same thing can typically be described in more than one way. Consequently, alternative language and synonyms may be used for any one or more of the terms discussed herein. Synonyms for certain terms are provided. However, a recital of one or more synonyms does not exclude the use of other synonyms, nor is any special significance to be placed upon whether or not a term is elaborated or discussed herein.

The invention is also described by means of particular examples. However, the use of such examples anywhere in the specification, including examples of any terms discussed below, is illustrative only and in no way limits the scope and meaning of the invention or of any exemplified term. Likewise, the invention is not limited to any particular preferred embodiments described herein. Indeed, many modifications and variations of the invention will be apparent to those skilled in the art upon reading this specification and can be made without departing from its spirit and scope. The invention is therefore limited only by the terms of the appended claims along with the full scope of equivalents to which the claims are entitled.

As used herein, “about” or “approximately” shall generally mean within 20 percent, preferably within 10 percent, and more preferably within 5 percent of a given value or range.

The specification makes reference to certain plant species. The following summarizes the various plant species referenced in this application, as well as shorthand and scientific names used as alternatives.

Broadleaf Weeds:

| Common name | RH Code | Bayer Code | Scientific name |
|---|---|---|---|
| Bidens | BID | BID PI | Bidens pilosa |
| Cocklebur | CKL | XAN ST | Xanthium pensylvanicum |
| Morningglory | MG | IPO HE | Ipomoea hederacea |
| Nightshade | NS | SOL NI | Solanum nigrum |
| Pigweed | PIG | AMA RE | Amaranthus retroflexus |
| Smartweed | SMT | POL PY | Polygonum lapathifolium |
| Teaweed | TEA | SID SP | Sida spinosa. |
| Velvetleaf | VEL | ABU TH | Abutilon theophrasti |

Grassy Weeds:

| Common name | RH Code | Bayer Code | Scientific name |
|---|---|---|---|
| Barnyardgrass | BYG | ECH CG | Echinochloa crus-galli |
| Blue panicum | BP | PAN AN | Panicum antidotale |
| Crabgrass | CRB | DIG SA | Digitaria sanguinalis |
| Foxtail | FOX | SET VI | Setaria viridis |
| Nutsedge | NUT | CYP ES | Cyperus esculentus |
| Ryegrass | RYE | LOL MU | Lolium multiflorum |
| Signalgrass | SIG | BRA PP | Brachiaria platyphylla |
| Sprangletop | SPR | LEF DU | Leptochloa dubia |

Crops:

| Common name | RH Code | Scientific name |
|---|---|---|
| Corn | CN | Zea mays |
| Cotton | COT | Gossypium hirsutum |
| Wheat | WHT | Triticum spp. |
| Rice | RI | Oryza sativa |
| Soybean | SOY | Glycine max |

The present invention is a plant life control composition containing an effective amount of a chlorine dioxide composition, preferably, a stabilized chlorine dioxide composition. The plant life control composition of the invention is an alternative to conventional, toxic herbicides that are used to control plant life. The present composition may also be used as a cleaner for removing contaminants from the external surface of plant life.

As used herein, the term “effective amount” when applied to controlling plant life includes an amount capable of regulating, stunning, destroying, managing, controlling or otherwise affecting the metabolism of plant life. When applied to cleaning plant life, an “effective amount” includes an amount capable of reducing or eliminating pesticides, herbicides, waxy residues, or other pollutants on the plant surface. The precise concentration of chlorine dioxide necessary in a given application will depend on several factors including the desired degree of plant life control, the type of plant life involved, the type of additives in the composition, and the like. Therefore, an “effective amount” of chlorine dioxide in the present composition may be selected in light of discrete circumstances encountered in a given application. Compositions containing effective amounts of chlorine dioxide (as used in the Examples below) have been tested and found to be an effective amount for the control of a wide variety of plant life. Compositions of chlorine dioxide as used in the Examples below are preferred. As used herein, the term “stabilized chlorine dioxide” refers to any solution containing chlorine dioxide made by any method which is suitably stable for the control or cleaning of plant life.

As used herein, “control” and “controlling” plant life refers to regulating, stunning, destroying, managing, or otherwise affecting the metabolism of plant life. As used herein, the term “plant life” means weeds, grasses, woody plants and other forms of flora for which herbicidal control may be sought, as well as fruits and vegetables which may become externally contaminated by toxic pesticides, herbicides, waxy residues and other pollutants. Also, as used herein, the term “waxy residue” means any wax-like material present on the external surfaces of a plant, whether natural or applied by the produce industry, and “pollutant” means any undesirable material that may deposited on the external surface of a plant, such as atmospheric residues.

Varying compositions of chlorine dioxide are effective plant life control agents and cleaning agents for the removal of contaminants from plant life. Preferably, these compositions include chlorine dioxide in stabilized form. While chlorine dioxide is a toxic gas only stable in solutions up to about 1% (10 g/L), stabilized chlorine dioxide is generally colorless, substantially odorless, highly stable and reported to have minimal to no detrimental effect on health or the environment when used at suggested concentrations. One relatively well understood forin of stabilized chlorine dioxide is sodium chlorite, as disclosed by Ringo, in U.S. Pat. No. 5,008,096, which is hereby incorporated by reference.

When sodium chlorite is subjected to chlorination or acidification, it releases chlorine dioxide. The chlorination of sodium chlorite is represented by the general formula:
2NaClO₂+Cl₂≈2ClO₂+2NaCl
and the acidification is represented by the general formula:
5NaClO₂+4HCl≈4ClO₂+5NaCl+2H₂O
Accordingly, by controlling these reactions, for example by adjusting the pH of the solution, a predictable source of chlorine dioxide can be established, and a solution containing an effective amount of stabilized chlorine dioxide made.

Other forms of stabilized chlorine dioxide and methods of making them are also known. One method of producing stabilized chlorine dioxide is disclosed by McNicholas et. al., in U.S. Pat. No. 3,271,242, which is hereby incorporated by reference. McNicholas also discloses that stabilized chlorine dioxide solutions may be dried to a powder which may subsequently be added to water to create a desired concentration of chlorine dioxide. Additional methods of producing chlorine dioxide solutions which may be suitable for use according to the present invention are disclosed by Guevara, in U.S. Pat. No. 2,701,781 (chlorine dioxide antiseptic stabilized with organic boron), McNicholas, in U.S. Pat. No. 3,278,447 (use of alkali metal percarbonate in generation of stabilized chlorine dioxide), Ripley et. al., in U.S. Pat. No. 5,078,908 (disinfectant compound including stabilized chlorine dioxide), and Daly, in U.S. Pat. No. 5,435,984 (chlorine dioxide generation using improved catalyst).

Conventionally, stabilized chlorine dioxide is broadly applied for oxidation or disinfection of certain materials. Stabilized chlorine dioxide has been used as a biocide to inhibit the growth of microorganisms in medical and personal hygiene, drinking water, wastewater and food processing, as well as in industrial applications such as, for example, paper pulp bleaching and oil field drilling. Also, as disclosed by Manchak, in U.S. Pat. No. 4,776,409, chlorine dioxide may be useful as a reactant to treat hazardous wastes.

In addition to possessing many desirable characteristics as a disinfectant, chlorine dioxide is capable of oxidizing and chlorinating many compounds or, as in the case of the present invention, a variety of plant life and contaminants which it comes in contact with. Stabilized chlorine dioxide compositions used in a wide range of solutions may produce a number of reactions that may include bleaching, photo-decomposition and oxidation. Furthermore, in the bleaching of cellulose by stabilized chlorine dioxide in paper pulp processes, it has been discovered that the order of reactivity is many times greater than ordinary industrial bleaches, which produce only slight depolymerization leaving the cellulose content generally unchanged. Despite its powerful activity, stabilized chlorine dioxide does not act as a chlorinating agent as does chlorine; therefore, the generation of halogenated organic compounds, such as chloroform, that would harm plant life or soil is generally minimal or eliminated.

Stabilized chlorine dioxide is available in various forms, including commercial disinfectant compositions, such as OX1-15™, OXINE®, PROOXINE® and PUROGENE® disinfectants manufactured by Bio-Cide International, Inc. (Norman, Okla.), and several stabilized chlorine dioxide products having similar concentrations manufactured by Alcide Corporation (Redmond, Wash.). Stabilized chlorine dioxide is preferably used in an aqueous solution. Chlorine dioxide compositions are believed to control plant life proportionally to the composition's concentration ratio. Stronger concentrations will achieve faster and more total control as opposed to weaker solutions. For most plant life control applications, solutions of less than 0.1 PPM chlorine dioxide have been tested and found effective for plant life control.

The effect of chlorine dioxide compositions on the metabolism of treated plants may occur within hours or several days without toxic effects, whereas conventional herbicides may take hours, days or weeks with toxic effects. When the composition of the present invention is applied to plant life it is quickly absorbed and transported throughout the plant, including the deepest roots. The plant then becomes wilted. The composition tends to accumulate in such areas of rapid growth as growing points, root tips, and areas of rapidly elongating shoots and roots. The degree of movement of the composition of the present invention is generally very high under many climatic conditions as compared to herbicides, such as 2, 4-D, which suffer from limited mobility, particularly under low light, cloudy or night time conditions.

The compositions of the present invention may also disrupt or destroy the internal structures of a plant and its cells and organs. Further, chlorophyll, the green pigment in plants that functions in photosynthesis by absorbing radiant energy from the sun, may also be destroyed. Consequently, after being sprayed, applied, or contacted with the present compositions, the plant life is typically pale green or yellow.

Additionally, the plant life control compositions of the present invention affect a much broader range of plants than most conventional herbicides which frequently require a specific biological fit. Also, during prolonged drought a wide range of plants may form waxy cuticle layers that act to seal the plant's leaf surface, and, thus, conventional herbicides are less effective because they are prevented from passing into the leaves to disrupt their metabolism. The present composition's oxidizing and bleaching actions, however, can break down waxy cuticles allowing the composition to quickly affect the plant's metabolism.

In addition to controlling plant life, when the compositions of the present invention are applied to plant life for relatively short periods and removed, contaminants may be cleaned from the plant life. Toxic pesticides, herbicides and other pollutants may be oxidized or otherwise rendered inert as the oxidizing and bleaching actions of the present compositions remove waxy residues which potentially trap such contaminants onto the plant life.

The present compositions for the control of plant life may also contain additives to assist their application, and/or effectiveness. For example, in herbicide applications additives which control the manner in which the composition reaches its target are desirable. Such additives may reduce the tendency of the composition, once airborne, to be carried to locations other than the target plant life. In particular, drift control agents may be useful additives for ensuring the composition reaches its intended target. Drift control agents typically may work by increasing the density of plant life control compositions, thus reducing the chance the composition may be carried away from the target on the wind. One example of a drift control agent may be MIST-CONTROL™ drift retardant made by the Miller Chemical and Fertilizer Corporation of Hanover, Pa. The active ingredient in MIST-CONTROL™ is a polyvinyl polymer. The manufacturer recommends using between 1 and 4 quarts of MIST-CONTROL™ (containing 2% active ingredient) per 100 gallons of spray solution.

In addition, in the application of the compositions of the present invention to plant life, materials which improve the flow characteristics of the present compositions may be desirable additives. In this regard, a flow agent, such as mineral oil or like flow agents, may be added to allow the composition to flow smoothly and predictably.

It is also desirable that the compounds of the present invention remain in contact with the plant life once applied, particularly in wet conditions such as those present during rainfall or in applications involving aquatic plants. Additives, such as surface retention agents, which improve the retention of the composition on plant surfaces may be preferable. For example, one commercially available product, SPRAY-MATE™ surface retention agent, manufactured by National Chelating Corp. (Orange, Calif.), has been tested and found effective on plants under wetted conditions. SPRAY-MATE™ surface retention agent contains 90%, by volume, glycol fatty acid and 10%, by volume, inert ingredients. The manufacturer directs the use of 10 drops of SPRAY-MATE™ surface retention agent per gallon of plant life control composition, though less is preferred if sufficient control is possible given the weather conditions.

Mineral oil or like agents may also be added to the composition to improve retention on certain types of plants, such as woody plants. If mineral oil or like agents are used as an additive, either as a flow agent or a surface retention agent, it is preferred that it is mixed thoroughly with the composition. An additional additive may be used to ensure complete dispersion. In particular, an emulsifier may be added to prevent the mineral oil or like agents from separating from the composition. The amount of emulsifier required will depend on the amount of mineral oil in the composition and is preferred to be enough to ensure complete dispersion of the mineral oil or like agents.

It is further desired that the compositions of the present invention may pose no risk of fire, either from ignition of dried plant life, or due to precursor residue remaining on the surface of plant life. Additives which may reduce the flammability of the compound and materials to which it is applied are therefore desirable. Fire retardant chemicals should, preferably, be non-toxic and inexpensive. For example, American Fire Retardant Corporation of Broussard, La. produces flame retardant chemicals according to the method disclosed by Friloux in U.S. Pat. No. 5,631,047 which may be suitable for use with the composition of the present invention.

For some applications, due to the varied functionality, more than one additive may preferably be added to the compositions. For example, in spraying a limited area of woody plants under wetted conditions it may be preferable to use a composition containing a drift control agent to ensure the composition stays within the target region, a surface retention agent, such as mineral oil or the like to improve retention on the plant surfaces, and an emulsifier to prevent the mineral oil or the like from separating from the composition.

The present compositions may be applied to plant life according to the invention in any conventional manner which contacts the desired plant life adequately. For example the application of, aqueous plant life control compositions include spraying or pouring onto plants. Compositions can also be applied by injection into the ground where they can contact the root structure of plants. For applications where it is desired only to affect specific plant life and not surrounding plants, very controlled application can be accomplished, for example with a spray device adapted to provide a very narrow stream of the composition. Conversely, where all plant life in an area is to be controlled, such as for a large field or an industrial site, a wide applicator, or even an aerial application, may be used.

In applications where only cleaning of a plant's exterior is desired, but not plant life control, the present composition may be removed from the exterior of the plant by conventional methods, after application and an effective retention period. For plant life cleaning applications, stabilized chlorine dioxide compositions of less than 0.1 PPM chlorine dioxide have been tested and found to be effective. Removal of the composition from the plant's exterior may consist of any effective method of separating the composition from the plant life including conventional washing steps or wiping off the plant life. The washing may be done with water. Removal of the composition may occur a short period after the application of the composition onto the plant life. However, various contaminants may require longer treatment periods or compositions with higher concentrations of stabilized chlorine dioxide for effective cleaning.

### EXAMPLES

The following examples are provided to illustrate rather than limit the scope of the invention.

### Example 1

In the following example, two commercially available proprietary disinfectant solutions, the first consisting of 3.35% acidified sodium chlorite, by weight, with the balance being water, and the second consisting of 15-16% acidified sodium chlorite, 1-3% sodium chloride, and 0-2% sodium chlorate, by volume, with the balance water, each containing less than 0.1 PPM chlorine dioxide, were used to evaluate the effectiveness of a stabilized chlorine dioxide-containing composition, and its use in methods for controlling and cleaning plant life.

Four vegetated test regions averaging 9 square feet in area were each sprayed with approximately 0.6 ounces of a stabilized chlorine dioxide-containing composition. The plant life in these regions consisted of an array of annuals and perennials, broad leaf weeds and grasses. Two regions each were sprayed on different days, but at the same time of day. In the first region, OX1-15™ disinfectant (a 15-16% acidified sodium chlorite, 1-3% sodium chloride, and 0-2% sodium chlorate composition, by volume, containing less than 0.1 PPM chlorine dioxide, the balance water) (Bio-Cide International, Inc.) was sprayed on the plant life. The 0.6 ounces of the composition was sufficient to wet substantially all parts of the vegetation with the composition. For the second region, OX1-15™ disinfectant was blended with 2½ drops of SPRAY-MATE™ surface retention agent (National Chelating Corp.) per quart. This composition was sprayed on vegetation which had been heavily wetted with water sprinklers.

In the third region, OXINE® disinfectant (a 3.35% acidified sodium chlorite composition, by weight, containing less than 0.1 PPM chlorine dioxide, the balance being water) (Bio-Cide International, Inc.) was sprayed on the plant life. For tile fourth region, OXINE® disinfectant was blended with 3 drops of SPRAY-MATE® surface retention agent per quart. This composition was sprayed on water-wetted vegetation.

In all four regions wilting was noticed within an average of 6 to 8 hours and the vegetation was completely wilted upon examination 24 hours later. These tests demonstrated the rapid and total action of the stabilized chlorine dioxide-containing compositions. The green color was generally removed from the vegetation, which demonstrated that the chlorophyll in the vegetation had been destroyed. The plant life could easily be pulled out of the ground, revealing a wilted root structure, and demonstrating the absorption and transport of the chlorine dioxide-containing composition throughout the plant.

### Example 2

The purpose of these experiments were used to evaluate the non-cropland preemergence (PRE) and postemergence (POST) weed control efficacy of two compositions of the invention.

PROOXINE® and OX1-15® were evaluated PRE and POST in non-replicated greenhouse screens. PROOXINE® 5% was applied PRE and POST at 20, 10, 6.6, 5.0, 3.3 and 2.5 kg/ha. OX1-15 was applied PRE and POST at 60, 30, 20, 15, 10, and 7.5 kg/ha. All treatments were applied in water with 1% v/v Sun-it II® (a multicomponent oil-surfactant system designed to maximize the performance of certain herbicides in post-emergence applications; manufactured by AGSCO, Inc., Brand Forks, N. Dak.) added to the spray solution. Treatments were applied with a laboratory belt sprayer calibrated to deliver 400 l/ha. The soil used in PRE testing was piano silt loam with 2.8% organic matter and a pH of 7.2. Growing media for the POST test was Metro Mix 350, a commercial mix containing no mineral soil. Visual ratings of weed control and crop injury were taken 17 days after treatment for PRE treatments and 14 days after treatment for POST treatments.

Applied PRE at 20 kg/ha, PROOXINE® failed to control any weeds in this test but did cause considerable injury to several weed and crop species (Table 1). PROOXINE® applied POST, at 20 kg/ha (full strength) gave 100% control of all broadleaf weeds in this test (Table 2). These weeds include Abutilon theophrasti (velvetleaf), Ambrosia artemisiifolia (common ragweed), Amaranthus rudis (common waterhemp), Ipomoea hederacea (ivyleaf morningglory) Stellaria media (common chickweed), and Xanthium strumarium (common cocklebur). Grass weed control was poor at this rate with only Setaria viridis (green foxtail) controlled 100% Three other grass weeds, Alopecurous myosuriodes (blackgrass), Digitaria sanguinalis (large crabgrass) and Echinochloa crus-galli (barnyardgrass) were controlled 4060%. Applied at rates lower than 20 kg/ha broadleaf weed control began to break.

OX1-15 gave similar results to PROOXINE® when applied PRE or POST. Applied PRE it failed to control any weed species in this test but did cause considerable injury to some weeds and crops. Applied POST at 15 kg/ha it controlled six of seven broadleaf species but failed to control any of the grass weeds in this test.

Post weed control was very fast with both compounds. Weed injury was evident within a couple hours after treatment and plant death several days after treatment.

TABLE 1
Weed control and crop injury; PRE, 17 days after treatment

| | Rate | | | | | | | | |
|---|---|---|---|---|---|---|---|---|---|
| Herbicide | (kg/ha) | XANST | CHEAL | AMATA | STEME | ABUTH | AMBEL | DIGSA | ECHCG |
| PROOXINE ® 5% | 20.0 | 30 | 60 | 65 | 75 | 70 | 60 | 55 | 55 |
| | 10.0 | 15 | 55 | 50 | 65 | 55 | 55 | 30 | 40 |
| | 6.6 | 10 | 25 | 20 | 50 | 55 | 30 | 30 | 30 |
| | 5.0 | 0 | 15 | 0 | 40 | 30 | 25 | 0 | 0 |
| | 3.3 | 0 | 15 | 0 | 35 | 15 | 10 | 0 | 0 |
| | 2.5 | 0 | 15 | 0 | 20 | 5 | 0 | 0 | 0 |
| | 60.0 | 50 | 80 | 85 | 85 | 65 | 65 | 55 | 60 |
| | 30.0 | 30 | 75 | 75 | 70 | 60 | 50 | 30 | 40 |
| | 20.0 | 25 | 65 | 55 | 65 | 50 | 20 | 25 | 30 |
| | 15.0 | 25 | 65 | 50 | 50 | 30 | 10 | 0 | 25 |
| | 10.0 | 25 | 60 | 20 | 50 | 20 | 5 | 0 | 10 |
| | 7.5 | 20 | 60 | 20 | 25 | 20 | 5 | 0 | 10 |
| Untreated | 0.0 | 0 | 0 | 0 | 0 | 0 | 0 | 0 | 0 |

| | Rate | | | | | | | |
|---|---|---|---|---|---|---|---|---|
| Herbicide | (kg/ha) | ESTVI | ALOMY | TRZAW | ORYSA | GLXMA | ZEAMX | IPOHE |
| PROOXINE ® 5% | 20.0 | 50 | 45 | 50 | 50 | 30 | 20 | 35 |
| | 10.0 | 20 | 40 | 30 | 25 | 15 | 20 | 30 |
| | 6.6 | 0 | 15 | 25 | 20 | 10 | 10 | 15 |
| | 5.0 | 0 | 10 | 15 | 0 | 10 | 10 | 15 |
| | 3.3 | 0 | 5 | 5 | 0 | 0 | 10 | 10 |
| | 2.5 | 0 | 5 | 0 | 0 | 0 | 10 | 5 |
| | 60.0 | 55 | 40 | 35 | 65 | 30 | 25 | 25 |
| | 30.0 | 45 | 25 | 25 | 15 | 20 | 15 | 20 |
| | 20.0 | 45 | 15 | 25 | 10 | 15 | 15 | 20 |
| | 15.0 | 20 | 10 | 25 | 0 | 10 | 5 | 15 |
| | 10.0 | 0 | 5 | 0 | 0 | 10 | 0 | 10 |
| | 7.5 | 0 | 5 | 0 | 0 | 10 | 0 | 10 |
| Untreated | 0.0 | 0 | 0 | 0 | 0 | 0 | 0 | 0 |

0 = n control or injury,
100 = complete kill

TABLE 2
Weed control crop injury; postemergence, 14 days after treatment.

| | Rate | | | | | | | | |
|---|---|---|---|---|---|---|---|---|---|
| Herbicide | (kg/ha) | XANST | CHEAL | AMATA | STEME | ABUTH | AMBEL | DIGSA | ECHCG |
| PROOXINE ®5% | 20.0 | 100 | 100 | 100 | 100 | 100 | 100 | 50 | 60 |
| | 10.0 | 100 | 85 | 100 | 80 | 100 | 100 | 35 | 35 |
| | 6.6 | 100 | 95 | 100 | 50 | 100 | 100 | 30 | 30 |
| | 5.0 | 85 | 75 | 100 | 65 | 100 | 65 | 10 | 20 |
| | 3.3 | 100 | 75 | 75 | 55 | 60 | 60 | 10 | 20 |
| | 2.5 | 100 | 45 | 75 | 55 | 60 | 60 | 10 | 20 |
| OX1-15 15% | 60.0 | 100 | 100 | 100 | 55 | 100 | 100 | 75 | 75 |
| | 30.0 | 100 | 100 | 100 | 100 | 100 | 100 | 60 | 65 |
| | 20.0 | 99 | 100 | 100 | 100 | 100 | 100 | 30 | 40 |
| | 15.0 | 100 | 100 | 100 | 100 | 100 | 100 | 30 | 40 |
| | 10.0 | 100 | 100 | 100 | 100 | 100 | 80 | 30 | 35 |
| | 7.5 | 99 | 85 | 100 | 55 | 100 | 70 | 25 | 25 |
| Untreated | 0.0 | 0 | 0 | 0 | 0 | 0 | 0 | 0 | 0 |

| | Rate | | | | | | | |
|---|---|---|---|---|---|---|---|---|
| Herbicide | (kg/ha) | SETVI | ALOMY | TRZAW | ORYSA | GLXMA | ZEAMX | IPOHE |
| PROOXINE ®5% | 20.0 | 100 | 40 | 20 | 15 | 100 | 65 | 100 |
| | 10.0 | 50 | 20 | 10 | 10 | 99 | 35 | 100 |
| | 6.6 | 30 | 10 | 10 | 10 | 99 | 35 | 100 |
| | 5.0 | 35 | 10 | 10 | 10 | 85 | 15 | 100 |
| | 3.3 | 30 | 10 | 5 | 10 | 85 | 15 | 100 |
| | 2.5 | 25 | 5 | 5 | 5 | 85 | 10 | 100 |
| OX1-15 15% | 60.0 | 100 | 50 | 15 | 10 | 100 | 85 | 100 |
| | 30.0 | 65 | 40 | 10 | 10 | 100 | 65 | 100 |
| | 20.0 | 85 | 30 | 10 | 10 | 100 | 30 | 100 |
| | 15.0 | 60 | 20 | 10 | 10 | 100 | 55 | 100 |
| | 10.0 | 60 | 20 | 10 | 10 | 90 | 20 | [symbol] |
| | 7.5 | 25 | 10 | 10 | 10 | 98 | 20 | [symbol] |
| Untreated | 0.0 | 0 | 0 | 0 | 0 | 0 | 0 | 0 |

0 = no control or injury,
100 = complete kill.

### Example 3

All POST crops and weeds plants were grown into separate square pots which measured 10×10 cm. The soil used was amended with Redi-Eartho Plug and Seedling Mix in a one to one ratio. Ten to twenty seeds per small seeded species were planted per pot. Five to ten seeds were planted with large seeded species. Seeds were sown 0.5 inches deep. Generally, POST plants were 7 to 21 days old (from planting) when sprayed. Grasses were in the 2-4 leaf stage and broadleaf weeds were in the 1-2 true leaf stage.

The spray volume was 50 gallons per acre (468 I/Ha). Rates of application (grams per hectare) varied depending on the concentration of chemical within each individual spray solution. Technical samples were dissolved in acetone. Formulations are suspended in water. All applications were made using a trolley belt sprayer. The test plants were placed on the belt inside the spray hood. Then the spray nozzle which is attached to the trolley, moves mechanically over the top of the plants. The spray nozzle delivers a flat fan spray pattern and is a typical nozzle used in herbicide field applications. The belt carries the plants out of the spray hood and into a drying chamber.

After spray application, the test plants were placed in a vented cabinet until dry, then placed in the greenhouse. The POST tests were watered by sub-irrigation for a period of 48 hours so that the water does not-contact the foliage. The trolley sprayer settings were as follows (50 (GPA) Gallons Per Acre or (468 L/Ha):

| | |
|---|---|
| NOZZLE | SS-8004-E Tee Jet |
| PRESSURE | 29 PSI |
| HEIGHT | 14 inches above target |
| SPRAY WIDTH | 20 inches |
| TROLLEY SPEED | 2 MPH |

Observations were made 2 to 3 weeks after treatment using a 0 (no effect) to 100% (complete control) rating system. The percent injury values were a composite value which entails chlorosis, necrosis, inhibition of growth or tip burning. All ratings were made compared to an untreated check.

All of the herbicide greenhouses are equipped with artificial lighting that provided 11,000 to 13,000 lux at the bench level. For comparison, mid-summer sunlight provided about 107,000 lux at Spring House. The greenhouses were maintained on 16 hour daylight/8 hour night cycle. The temperatures range upward from a minimum of 72 degrees Fahrenheit. A series of coolers kept summer temperatures below 95 degrees Fahrenheit. Shading cloth was used in the summer to help maintain reasonable temperatures.

The results are shown in Table 3.

TABLE 3a
% POST Control of Broadleaf Weeds 14 Days after Treatment

| | | | Avg | | | | | | | | |
|---|---|---|---|---|---|---|---|---|---|---|---|
| Composition | Dose | | Dicot | BID | CKL | MG | NS | PIG | SMT | TEA | VEL |
| PROOXINE ® | ⅛ | strength | 57 | 80 | 80 | 60 | 40 | 40 | 40 | 60 | 60 |
| ″ | ¼ | strength | 76 | 80 | 100 | 80 | 60 | 60 | 60 | 80 | 90 |
| ″ | ½ | strength | 86 | 80 | 100 | 90 | 60 | 80 | 100 | 80 | 100 |
| OX1-15 | ½ | strength | 52 | 60 | 80 | 40 | 40 | 40 | 40 | 60 | 60 |
| ″ | ⅙ | strength | 78 | 85 | 100 | 60 | 60 | 60 | 85 | 80 | 95 |
| ″ | ⅓ | strength | 88 | 85 | 100 | 80 | 85 | 80 | 100 | 80 | 95 |
| Paraquat | 600 | g/ha | 98 | 100 | 100 | 100 | 100 | 100 | 100 | 85 | 100 |

TABLE 3b
% POST Control of Grassy Weeds 14 Days after Treatment

| | | | Avg | | | | | | | | |
|---|---|---|---|---|---|---|---|---|---|---|---|
| Composition | Dose | | Monocot | BP | BYG | CRB | FOX | NUT | RYE | SIG | SPR |
| PROOXINE ® | ⅛ | strength | 10 | 20 | 20 | 20 | 20 | 0 | 0 | 0 | 0 |
| ″ | ¼ | strength | 11 | 25 | 20 | 20 | 30 | 0 | 0 | 0 | 0 |
| ″ | ½ | strength | 27 | 30 | 40 | 30 | 80 | 20 | 20 | 0 | 0 |
| OX1-15 | 1/12 | strength | 10 | 20 | 20 | 20 | 20 | 0 | 0 | 0 | 0 |
| ″ | ⅙ | strength | 13 | 20 | 30 | 20 | 40 | 0 | 0 | 0 | 0 |
| ″ | ⅓ | strength | 23 | 40 | 40 | 30 | 40 | 20 | 20 | 0 | 0 |
| Paraquat | 600 | g/ha | 93 | 100 | 95 | 90 | 90 | 85 | 100 | 85 | 100 |

TABLE 3c
% Crop Injury 14 Days after Treatment

| Composition | Dose | | CN | COT | RI | SOY | WHT |
|---|---|---|---|---|---|---|---|
| PROOXINE ® | ⅛ | strength | 0 | 95 | 0 | 80 | 0 |
| ″ | ¼ | strength | 20 | 100 | 0 | 90 | 0 |
| ″ | ½ | strength | 30 | 100 | 10 | 100 | 5 |
| OX1-15 | 1/12 | strength | 20 | 95 | 0 | 100 | 0 |
| ″ | ⅙ | strength | 20 | 100 | 0 | 95 | 0 1 |
| ″ | ⅓ | strength | 20 | 100 | 15 | 100 | 10 |
| Paraquat | 600 | g/ha | 85 | 100 | 100 | 100 | 100 |

### Example 4

In order to determine the potential of the stabilized salts from stabilized chlorine dioxide composition of the invention, the materials were subjected to a multispecies screen, where they were evaluated for POST activity, and assayed for any potential PRE activity. The POST screening was carried out on plants in a small stage of growth (1 to 2 leaf stage), and the materials were sprayed to run-off to insure complete coverage. Visual assessments of percent control were noted 14 days after post application and 21 days after PRE applications.

All test species used in POST trials were grown from seed in a peat based potting mixture (metromix). Plants were propagated under glasshouse conditions with supplementary lighting. Plants were sub-irrigated following application. Growth stages at time of application were noted.

All test species used in PRE trials were grown in a sandy clay loam soil. Plants were raised under glasshouse conditions with supplementary lighting. Following application overhead irrigation was utilized to move the potential herbicides into the germinating seed zone.

PROXINE® and OX1-15 were tested POST at full strength and at 4 subsequent rates derived by 1:1 serial dilutions with water. Based on the active ingredient the rates applied were: 50,000, 25,000, 12,500, 6250, and 3130 ppm (parts per million) of PROXINE®, and 150,000, 75,000, 37,500, 18,800 and 9,380 ppm of OX1-15. All treatments were sprayed to run off using a hand held Devilbiss atomizer.

For soil applied applications PROXINE® and OX1-15 were tested PRE at full strength and at 4 subsequent rates derived by 1:1 serial dilutions with water. Based on the active ingredient and the area of the pot treated, the rates applied were: 125,000, 62,500, 31,250, 15,625 and 7812 g/ha (grams active per hectare) of PROXINE®, and 375,000, 187,500, 93,750, 46,875, and 23,438 g/ha of OX1-15. Application was made using a hand held syringe fitted with a hollow cone nozzle.

Percent weed control was evaluated visually on a 0-100 linear scale with 0 representing no control and 100 representing total control. Percent crop injury was evaluated visually on a 0-100 linear scale with 0 representing no injury and 100 plant death.

These stabilized salts were characterized for control of 6 grass weeds, 9 broadleaf weeds and 1 sedge. Plants sprayed post emergence with high volumes of PROXINE® and OX1-15 exhibited herbicidal injury within two hours after application. Within 24 hours after application many of the plant species were dead. No crop selectivity was noted for either of the materials, however, grass crops were more tolerant of these stabilized salts than broadleaf crops.

OX1-15 provided broad-spectrum annual broadleaf weed control. Canada thistle, CIRAR, a perennial broadleaf weed was exhibiting regrowth of initial burndown from OX1-15 within 8 days after application. Regrowth of annual broadleaf weeds, CHEAL and EPHHL, as well as CIRAR was noted with ProOXINE.

POST grass weed control was variable for both OX1-15 and PROXINE®. Cool season grasses, ALOMY and AVEFA, were not well controlled even when treated full strength with these stabilized salts. The majority of the warm season grasses were well controlled with the higher rates of OX1-15, however, significant regrowth of ECHCG was observed at all rates tested. Overall, PROXINE® was less effective than OX1-15 but provided a similar spectrum of weed control.

Broad-spectrum post emergence weed control coupled with the lack of soil availability has facilitated the multiple utilities and wide flexibility offered by glyphosate. To fully characterize the stabilized salts it was prudent to insure that there was no weed or crop injury delivered by soil applications of either material. PROXINE® and OX1-15 were applied PRE to 4 broadleaf crops, 3 grass crops, 6 broadleaf weeds and 6 grass weeds. Significant injury to 3 of the 4 broadleaf crops was noted with both PROXINE® and OX1-15. Grass crops were more tolerant than broadleaf crops but stunting and tip burn were noted with these crops as well.

TABLE 4
A list of weed species used in the biological
evaluation of PROXINE ® and OX1-15

| Scientific Name | Common Name (U.S.) |
|---|---|
| Abutilon theophrasti | Velvetleaf |
| Alopecurus myosuroides | Blackgrass |
| Amaranthus retroflexus | Pigweed |
| Avena fatua | Wild oat |
| Chenopodium album | Common Lamsquarter |
| Cirsium arvense | Canada thistle |
| Cyperus esculentus | Yellow nutsedge |
| Digitaria sanguinalis | Crab grass |
| Echinochloa crus-galli | Barnyardgrass |
| Euphorbia heterophylla | Wild poinsettia |
| Ipomoea hederaceae | Ivyleaf morningglory |
| Polygonum convolvulus | Wild buckwheat |
| Setaria faberi | Giant foxtail |
| Stellaria media | Chickweed |
| Viola tricolor | Pansy |
| Xanthium strumarium | Cocklebur |

TABLE 5a
Weed Control and Crop Injury for PROXINE ® applied
post-emergence to a range of crop and target weed species
in a small stage of growth, 14 days after application

| | | | 50000 | 25000 | 125000 | 6250 | 3130 |
|---|---|---|---|---|---|---|---|
| | *Growth | | PPM | PPM | PPM | PPM | PPM |
| SPECIES | Stage | | Percent | | | | |
| oil seed | cotyledons | | 100 | 100 | 90 | 70 | 50 |
| rape | | | | | | | |
| soybean | 2 | L | 100 | 100 | 100 | 90 | 70 |
| corn | 1 | L | 50 | 40 | 30 | 20 | 20 |
| rice | 2 | L | 60 | 50 | 40 | 30 | 20 |
| wheat | 2 | L | 50 | 40 | 20 | 10 | 0 |
| STEME | 4 | L | 100 | 100 | 90 | 80 | 70 |
| XANST | 3 | L | 100 | 100 | 100 | 90 | 70 |
| CHEAL | 5 | L | 100 | 100 | 90 | 50 | 40 |
| IPOHE | 1 | L | 100 | 100 | 90 | 90 | 80 |
| ABUTH | 2 | L | 100 | 100 | 100 | 100 | 70 |
| VIOTR | 3 | L | 100 | 100 | 90 | 90 | 80 |
| POLCO | 1 | L | 100 | 100 | 100 | 100 | 100 |
| EPHHL | 1 | L | 100 | 100 | 90 | 70 | 60 |
| CIRAR | 4-6 | L | 90 | 70 | 70 | 60 | 60 |
| **BW ave | | | 99 | 97 | 91 | 81 | 70 |
| ALOMY | 1 | L | 70 | 30 | 10 | 0 | 0 |
| AVEFA | 2 | L | 50 | 40 | 20 | 10 | 10 |
| ECHCG | 2 | L | 90 | 50 | 40 | 30 | 20 |
| DIGSA | 2 | L | 100 | 100 | 90 | 50 | 30 |
| SETFA | 2 | L | 100 | 90 | 70 | 50 | 40 |
| SORVU | 1 | L | 90 | 70 | 60 | 30 | 20 |
| ***GW ave | | | 83 | 63 | 48 | 28 | 20 |
| CYPES | 3 | L | 60 | 50 | 40 | 40 | 30 |

*Growth Stage = leaf stage (L)
**BW ave = overall broadleaf weed average
***GW ave = overall grass average

TABLE 5b
Weed Control and Crop Injury for OX1-15 applied post-emergence
to a range of crop and target weed species in a small
stage of growth, 14 days after application

| | | | 150000 | 75000 | 37500 | 18800 | 9380 |
|---|---|---|---|---|---|---|---|
| | *Growth | | PPM | PPM | PPM | PPM | PPM |
| SPECIES | Stage | | Percent | | | | |
| oil seed | cotyledons | | 100 | 100 | 100 | 90 | 50 |
| rape | | | | | | | |
| soybean | 2 | L | 100 | 100 | 100 | 90 | 90 |
| corn | 1 | L | 40 | 30 | 30 | 20 | 20 |
| rice | 2 | L | 100 | 90 | 80 | 50 | 30 |
| wheat | 2 | L | 50 | 40 | 30 | 20 | 10 |
| STEME | 4 | L | 100 | 100 | 100 | 100 | 100 |
| XANST | 3 | L | 100 | 100 | 100 | 90 | 90 |
| CHEAL | 5 | L | 100 | 100 | 100 | 100 | 100 |
| IPOHE | 1 | L | 100 | 100 | 100 | 90 | 90 |
| ABUTH | 2 | L | 100 | 100 | 100 | 100 | 90 |
| VIOTR | 3 | L | 100 | 100 | 100 | 100 | 100 |
| POLCO | 1 | L | 100 | 100 | 90 | 90 | 85 |
| EPHHL | 1 | L | 100 | 100 | 100 | 90 | 90 |
| CIRAR | 4-61 | - | 80 | 75 | 70 | 70 | 50 |
| **BW ave | | | 98 | 97 | 96 | 92 | 88 |
| ALOMY | 1 | L | 50 | 40 | 30 | 30 | 20 |
| AVEFA | 2 | L | 50 | 40 | 40 | 30 | 20 |
| ECHCG | 2 | L | 70 | 70 | 60 | 50 | 30 |
| DIGSA | 2 | L | 100 | 100 | 100 | 100 | 90 |
| SETFA | 2 | L | 100 | 100 | 100 | 90 | 70 |
| SORVU | 1 | L | 100 | 100 | 90 | 80 | 70 |
| ***GW ave | | | 78 | 75 | 70 | 63 | 50 |
| CYPES | 3 | L | 80 | 80 | 70 | 70 | 60 |

*Growth Stage - leaf stage (L)
**BW ave = overall broadleaf weed average
***GW ave = overall grass weed average

TABLE 6a
Weed Control and Crop Injury 21 days after pre-emergence application
of PROXINE ® on a range of crop and target weed species

| | 125000 | 62500 | 31250 | 15625 | 7812 |
|---|---|---|---|---|---|
| | g/ha | g/ha | g/ha | q/ha | g/ha |
| SPECIES | Percent | | | | |
| cotton | 50 | 40 | 20 | 20 | 0 |
| soybean | 40 | 30 | 20 | 10 | 0 |
| sugar beet | 60 | 50 | 40 | 20 | 0 |
| oilseed rape | 0 | 0 | 0 | 0 | 0 |
| XANST | 85 | 70 | 70 | 40 | 0 |
| CHEAL | 80 | 80 | 70 | 30 | 30 |
| IPOHE | 0 | 0 | 0 | 0 | 0 |
| AMARE | 80 | 50 | 30 | NT | NT |
| ABUTH | 80 | 80 | 75 | 75 | 70 |
| EPHHL | 60 | 50 | 50 | 30 | 0 |
| *BW ave | 64 | 55 | 49 | 36 | 20 |
| Corn | 30 | 30 | 20 | 10 | 10 |
| Rice | 50 | 40 | 30 | 20 | 0 |
| Wheat | 30 | 20 | 10 | 0 | 0 |
| ALOMY | 0 | 0 | 0 | 0 | 0 |
| AVEFA | 50 | 30 | 20 | 0 | 0 |
| ECHCG | 0 | 0 | 0 | 0 | 0 |
| DIGSA | 0 | 0 | 0 | 0 | 0 |
| SETFA | 0 | 0 | 0 | 0 | 0 |
| SORVU | 0 | 0 | 0 | 0 | 0 |
| **GW ave | 8.3 | 5 | 3.3 | 0 | 0 |

*BW ave = overall broadleaf weed average
**GW ave = overall grass weed average

TABLE 6b
Weed Control and Crop Injury for OX1-1A 5 applied pre-emergence
to a range of crop and target weed species

| | 375000 | 187500 | 93750 | 46875 | 23438 |
|---|---|---|---|---|---|
| | g/ha | g/ha | g/ha | g/ha | g/ha |
| SPECIES | Percent | | | | |
| cotton | 90 | 80 | 80 | 80 | 0 |
| soybean | 90 | 70 | 50 | 20 | 0 |
| sugar beet | 50 | 40 | 40 | 20 | 20 |
| oilseed rape | 0 | 0 | 0 | 0 | 0 |
| XANST | 80 | 80 | 80 | 40 | 20 |
| CHEAL | 90 | 90 | 80 | 80 | 40 |
| IPOHE | 0 | 0 | 0 | 0 | 0 |
| AMARE | 80 | 80 | 70 | 50 | 0 |
| ABUTH | 90 | 90 | 90 | 80 | 40 |
| EPHHL | 50 | 50 | 40 | 40 | 20 |
| *BW ave | 65 | 65 | 60 | 48 | 20 |
| Corn | 30 | 30 | 20 | 20 | 0 |
| Rice | 50 | 30 | 30 | 20 | 20 |
| Wheat | 30 | 20 | 10 | 0 | 0 |
| ALOMY | 0 | 0 | 0 | 0 | 0 |
| AVEFA | 30 | 20 | 20 | 10 | 0 |
| ECHCG | 40 | 20 | 0 | 0 | 0 |
| DIGSA | 0 | 0 | 0 | 0 | 0 |
| SETFA | NT | 80 | 80 | 40 | 0 |
| SORVU | 50 | 30 | 0 | 0 | 0 |
| **GW ave | 24 | 25 | 17 | 8.3 | 0 |

*BW ave = overall broadleaf weed average
**GW ave = overall grass weed average

### Example 6

In the following example, two commercially available proprietary disinfectant solutions, the first consisting of 3.35% acidified sodium chlorite, by weight, with the balance being water, and the second consisting of 15-16% acidified sodium chlorite, 1-3% sodium chloride, and 0-2% sodium chlorate, by volume, with the balance water, each containing less than 0.1 PPM chlorine dioxide, were used to evaluate the effectiveness of a stabilized chlorine dioxide-containing composition, and its use in methods for controlling and cleaning plant life.

Tomatoes, apples, pears and cucumbers which had been sprayed with pesticide and heavily waxed were obtained. Four trials were run on the produce. In the first two trials, three of each of these fruits and vegetables were dipped for at least 30 seconds in a 2 quart bowl of OXINE® disinfectant (a 3.35% acidified sodium chlorite composition, by weight, containing less than 0.1 PPM chlorine dioxide, the balance being water) (Bio-Cide International, Inc.), and then rinsed in cold water and dried. The wax and any contaminants contained therein were degraded and the waxy feel was removed from the produce, demonstrating that the stabilized chlorine dioxide containing composition had broken down the waxy residue and pesticide and cleaned the plant life. The procedure followed in the first trial was repeated in a second trial with similar results.

In the third and fourth trials, the produce was sprayed with OXINE® disinfectant, rinsed in cold water, and dried. This procedure also resulted in the removal of the waxy residue and trapped contaminants from the plant surface, and demonstrates the ability of a stabilized chlorine dioxide-containing compositions to remove waxy residues and contaminants from a plant's surface. The procedure followed in third trial was repeated in a fourth trial with similar results. While disinfectant compositions containing stabilized chlorine dioxide are known for use on plants, it is surprising that when compositions containing an effective amount of stabilized chlorine dioxide are applied according to the method of the invention, the composition removes waxy residues, pesticides, herbicides and pollutants from the exterior of plant life.

It will be understood that each of the elements described herein may be modified or may also find utility in other applications differing from those described above. While particular embodiments of the invention have been illustrated and described, it is not intended to be limited to the details shown, since various modifications and substitutions may be made without departing in any way from the spirit of the present invention as defined by the following claims.

All patents, applications, publications, test methods, literature, and other materials cited herein are incorporated herein by reference.

1. (canceled)

2. (canceled)

3. (canceled)

4. (canceled)

5. (canceled)

6. A method of stunning or destroying non-weed plant growth, comprising the step of:
contacting a non-weed plant with a composition comprising an effective amount of chlorine dioxide.

7. The method of claim 6 wherein said composition further comprises an additive selected from the group consisting of a surface retention agent, a drift control agent, a flow agent, a fire retardant agent, and mixtures thereof.

8. The method of claim 7, wherein the surface retention agent is a mineral oil.

9. The method of claim 7, wherein the composition further comprises an emulsifier.

10. The method of claim 7, wherein the additive comprises a drift control agent.

11. The method of claim 7, wherein the additive comprises a flow agent.

12. The method of claim 6, wherein the contacting step comprises spraying the composition on the plant.

13. The method of claim 6, wherein the contacting step comprises introducing the composition into an area of earth surrounding a root region of the plant.

14. The method of claim 6, wherein the method results in wilting of the plant.

15. The method of claim 6, wherein the method results in the death of the plant.

16. A method for cleaning a contaminated plant, fruit or vegetable comprising the steps of:
contacting an external surface of an externally contaminated plant, fruit, or vegetable with a composition comprising an effective amount of chlorine dioxide; and
removing the composition from the plant, fruit or vegetable,
whereby the plant, fruit or vegetable is cleaned.

17. The method of claim 16 wherein the contacting step includes spraying the plant, fruit or vegetable with the composition.

18. The method of claim 16 wherein the contacting step includes dipping the plant, fruit or vegetable in the composition.

19. The method of claim 16 where the removing step includes the step of rinsing the plant, fruit or vegetable with water.

20. The method of claim 16, wherein the externally contaminated plant has a waxy residue prior to the contacting step.

21. The method of claim 6, wherein the non-weed plant is a crop.

22. The method of claim 6, wherein the non-weed plant is an annual or a perennial.

23. The method of claim 16, wherein the contacting step comprises contacting a fruit or vegetable.

24. A method of treating a plant, fruit or vegetable comprising contacting an external surface of a plant, fruit, or vegetable with a composition comprising an amount of chlorine dioxide effective to clean or render inert an contaminant on the external surface of the plant, fruit or vegetable without stunning or destroying the plant, fruit or vegetable.
